(19) United States
(12) Patent Application Publication
(10) Pub. No.: US 2015/0017825 A1
(43) Pub. Date: Jan. 15, 2015

(54) Lever-Type Connector

(71) Applicant: Yazaki Corporation, Minato-ku, Tokyo (JP)

(72) Inventor: Jun Kamiya, Toyota-shi (JP)

(21) Appl. No.: 14/377,545

(22) PCT Filed: Feb. 7, 2013
(86) PCT No.: PCT/JP2013/052904

§ 371 Date: Aug. 8, 2014

(30) Foreign Application Priority Data
Feb. 8, 2012 (JP) 2012-025349

(51) Int. Cl. H01R 13/629

(52) U.S. Cl. CPC H01R 13/62938
USPC 439/153

(57) ABSTRACT

A fitting operation lever includes rotation fulcrum holes rotationally engaged with boss portions on a first connector housing, boss guiding grooves enabling the boss portions and the rotation fulcrum holes to be engaged with or disengaged, flexible arms extending from lever main bodies so as to be superposed on outer surfaces of an outer cylindrical wall portion of a second connector housing a fitting starting time of the connector housings, and action point projecting portions provided at distal end sides of the flexible arms so as to be engaged with lever locking holes in the outer cylindrical portion at the fitting starting time. The engagement of the action point projecting portions with the lever locking holes can be released by deflecting and displacing the distal end sides in a direction in which the distal end sides move away from the outer surfaces.

### TECHNICAL FIELD

The present invention relates to a lever-type connector.

### BACKGROUND ART

FIG. 14 shows a conventional example of lever-type connector.

This lever-type connector 100 is disclosed in Patent Document 1 below and includes a first connector housing 110, a second connector housing 120 in which the first connector housing 110 is fitted for connection, and a fitting operation lever 130 which is rotatably mounted on the first connector housing 110.

The second connector housing 120 has an outer cylindrical wall portion (a hood portion) 121 into which the first connector housing 110 is inserted.

The fitting operation lever 130 is rotatably mounted on boss portions 111 which are provided on outer surfaces of the first connector housing 110 so as to project therefrom as a lever member which reduces operation forces to be exerted when the first connector housing 110 and the second connector housing 120 are fitted together and are released from the fitted state.

The fitting operation lever 130 includes, as shown, a pair of lever main bodies 131 which are disposed opposite to each other so as to hold a pair of outer surfaces of the first connector housing 110 therebetween, a connecting member 132 which connects together end portions of the pair of lever main bodies 131, rotation fulcrum holes 133 which are formed in the lever main bodies 131 for rotatable engagement with the boss portions 111 on the outer surfaces of the first connector housing 110, and action point projecting portions 134 which are brought into engagement with lever locking holes 122 which are formed in outer surfaces of the outer cylindrical wall portion 121 when fitting is started where the first connector housing 110 and the second connector housing 120 are positioned in a fitting start position.

In the case of the illustrated example, the connecting member 132 doubles as an application point portion which receives an operation force with which the lever main bodies 131 are rotated on the boss portions 111 as a rotational center.

In the lever-type connector 100 of Patent Document 1, the first connector housing 110 and the second connector housing 120 are fitted together for connection in the following procedure.

Firstly, as shown in the figure, the fitting operation lever 130 is mounted rotatably on the first connector housing 110. Next, as indicated by an arrow X1 in FIG. 14, a distal end portion of the first connector housing 110 is inserted into the outer cylindrical wall portion 121 of the second connector housing 120, so that the first connector housing 110 and the second connector hosing 120 are aligned with the fitting starting position, bringing the action point projecting portions 134 of the fitting operation lever 130 into engagement with the lever locking holes 122 in the second connector housing 120.

Next, by pressing downwards the connecting member 132 of the fitting operation lever 130, the fitting operation lever 130 is rotated as indicated by an arrow R1 in FIG. 14. The second connector housing 120 is pulled towards the first connector housing 110 by means of the rotational operation of the fitting operation lever 130, whereby the connector housings are completely fitted together.

When the fitting of the connector housings is released, the connecting member 132 is rotated in an opposite direction to the direction indicated by the arrow R1 in FIG. 14, whereby the connector housings are separated from each other.

### PRIOR ART DOCUMENT

### Patent Document

[Patent Document 1] Japanese Patent Publication No. 3442661

### SUMMARY OF THE INVENTION

### Problem that the Invention is to Solve

In the case of the lever-type connector 100 of Patent Document 1, however, the fitting operation lever 130 cannot be dismounted from the first connector housing 110 with the connector housings fitted together.

Because of this, in the case of the lever-type connector 100 of Patent Document 1, the weight of the fitting operation lever 130 is still acting on the connector housings even in an actual used state where the housings are fitted and connected completely together, having constituted a cause for calling for an increase in the weight of the connector.

Additionally, in the case of the lever-type connector 100 of Patent Document 1, the fitting operation lever 130 has to be attached to the lever-type connector 100 at all times, leading to a problem that an increase in cost due to the increase in the number of parts is called for.

Then, relating to solving the problems, an object of the invention is to provide a lever-type connector which can realize a reduction in cost by reducing the number of parts and a reduction in weight thereof when in use.

### Means for Solving the Problem

The object of the invention is achieved by the following configurations.

(1) A lever-type connector, including:

a first connector housing;

a second connector housing having an outer cylindrical wall portion into which the first connector housing is inserted and configured to be fitted together with the first connector housing for connection; and

a fitting operation lever which is rotatably mounted on the first connector housing as a lever member which reduces operation forces to be exerted when the first connector housing and the second connector housing are fitted together and are released from the fitted state;

wherein the fitting operation lever includes:

a pair of lever main bodies which are disposed opposite to each other so as to hold a pair of outer surfaces of the first connector housing therebetween;

rotation fulcrum holes, which are formed on inner surfaces of the lever main bodies which lie to be opposite to the outer surfaces of the first connector housing, and which are depressed thereinto for rotational engagement with boss portions which are provided individually on the outer surfaces of the first connector housing so as to project therefrom;

boss guiding grooves which are formed on inner surfaces of the lever main bodies and depressed thereinto so as to enable an engagement or disengagement between the boss portions and the rotation fulcrum holes by allowing the lever main bodies to be placed on or displaced from the first connector housing along a direction in which the connector housings are fitted together;

flexible arms which extend from the lever main bodies so as to be superposed on outer surfaces of the outer cylindrical wall portion at a fitting starting time when the first connector housing and the second connector housing are started to be aligned with a fitting starting position in a state that the rotation fulcrum holes are in rotatable engagement with the boss portions;

operation point projecting portions which are provided at distal end sides of the flexible arms so as to project therefrom for engagement with lever locking holes which are formed in the outer surfaces of the outer cylindrical wall portion when the connector housings are started to be fitted together; and

an application point portion which receives an operation force that is applied to rotate the lever main bodies on the boss portions as a center of rotation, and

wherein the engagement between the action point projecting portions and the lever locking holes can be released by deflecting and displacing the distal end sides of the flexible arms in a direction in which the distal end sides of the flexible arms move away from the outer surfaces of the outer cylindrical wall portion.

According to the configuration described under (1) above, when the fitting operation lever which is mounted on the first connector housing 10 is rotated in the predetermined direction with the connector housings aligned with the fitting starting position, the fitting operation lever functions as a lever member to move the connector housings in a direction in which the connector housings are fitted together deeply, whereby the connector housings are fitted together completely.

In addition, with the connector housings fitted together completely, the flexible arms of the fitting operation lever are exposed to the outer surfaces of the outer cylindrical wall portion of the second connector housing and can be touched from the outside. Because of this, the engagement between the action point projecting portions and the lever locking holes can be released by deflecting and displacing the distal end sides of the flexible arms in a direction in which the distal end sides of the flexible arms move away from the outer surfaces of the outer cylindrical wall portion.

In addition, the fitting operation lever can be placed or displaced along the fitting direction of the connector housings, whereby the boss portions can be brought into engagement with or disengagement from the rotation fulcrum holes. Because of this, with the coupled state of the fitting operation lever to the second connector housing canceled by releasing the engagement of the action point action point projecting portions with the lever locking holes, the fitting operation lever can simply be disengaged from both the connector housings by removing the fitting connection lever from the first connector housing.

Namely, according to the configuration of (1) above, after the connector housings are fitted together completely for connection, the fitting operation lever is disengaged from both the connector housings, thereby making it possible to realize a reduction in weight of the lever-type connector when in use.

Additionally, the fitting operation lever which is so disengaged can be used to execute a fitting operation on another lever-type connector. This enables a normal parts set for the fitting operation lever to be made up of only a first connector housing and a second connector housing excluding a fitting operation lever, thereby making it possible to realize a reduction in cost by reducing the number of parts involved in the parts set.

Thus, the invention has been described briefly. Further, the details of the invention will be clarified further by perusing a mode for carrying out the invention (hereinafter, referred to as an “embodiment”) that will be described below by reference to accompanying drawings.

### BRIEF DESCRIPTION OF DRAWINGS

FIG. 1 is an exploded perspective view of an embodiment of a lever-type connector according to the invention.

FIG. 2 is a side view of a first connector housing shown in FIG. 1 (a view as seen in a direction indicated by arrow A).

FIG. 3 is a side view of a second connector housing shown in FIG. 1 (a view as seen in a direction indicated by arrow B).

FIG. 4 is a view of a fitting operation lever shown in FIG. 1 as seen in a direction indicated by an arrow C therein.

FIG. 5 is a side view of a state in which the first connector housing on which the fitting operation lever shown in FIG. 1 is mounted and the second connector housing are disposed so as to be aligned vertically before the connector housings are aligned with a fitting starting position.

FIG. 6 is a side view of a state resulting when the first connector housing on which the fitting operation lever shown in FIG. 1 is mounted and the second connector housing are started to be fitted together where the connector housings are aligned with the fitting starting position.

FIG. 7 is a side view of a state in which the fitting operation lever is rotated in a predetermined direction from the state resulting when the connector housings are started to be fitted together, whereby the connector housings are fitted together completely.

FIG. 8 is an explanatory diagram of an operation in which distal ends of flexible arms of the fitting operation lever are deflected outwards after the connector housings are fitted together completely in order to release the engagement of action point projecting portions of the fitting operation lever with lever locking holes of the second connector housing.

FIG. 9 is a side view of a state in which the fitting operation lever is disengaged from the connector housings which are fitted together completely.

FIG. 10 is a connector rear view which shows a state in which the fitting operation lever whose engagement with the second connector housing is released is removed from the connector housings.

FIG. 11 is a connector front view which depicts an operation in which the fitting operation lever is mounted again on the connector housings which are fitted together completely.

FIG. 12 is a side view of a state in which the fitted state of the connector housings is returned to the state in which the connector housings are aligned with the fitting starting position by rotating the fitting operation lever is rotated in a reverse direction to the direction in which the fitting operation lever is rotated to fit the connector housings together.

FIG. 13 is a side view of a state in which the first connector housing is pulled apart from the second connector housing.

FIG. 14 is an exploded perspective view of a conventional lever-type connector.

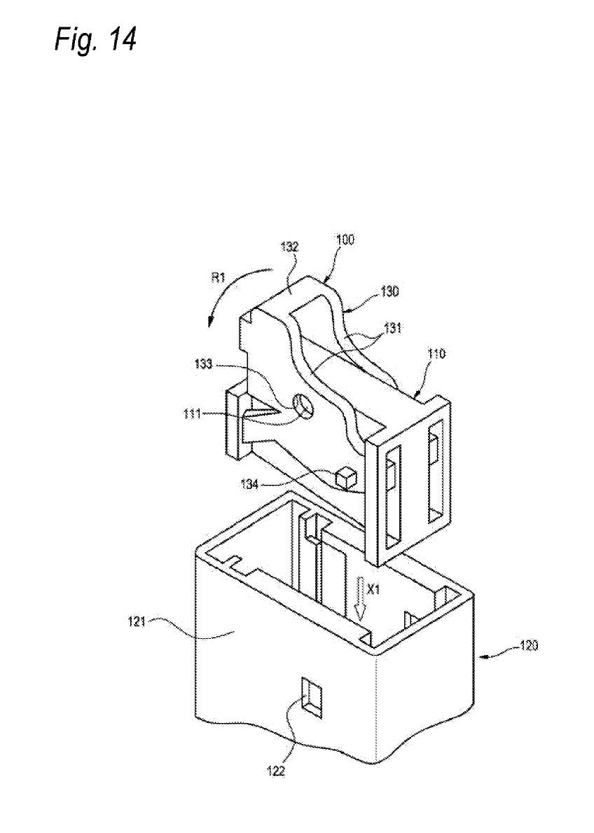

### MODE FOR CARRYING OUT THE INVENTION

Hereinafter, a preferred embodiment of a lever-type connector according to the invention will be described in detail by reference to the drawings.

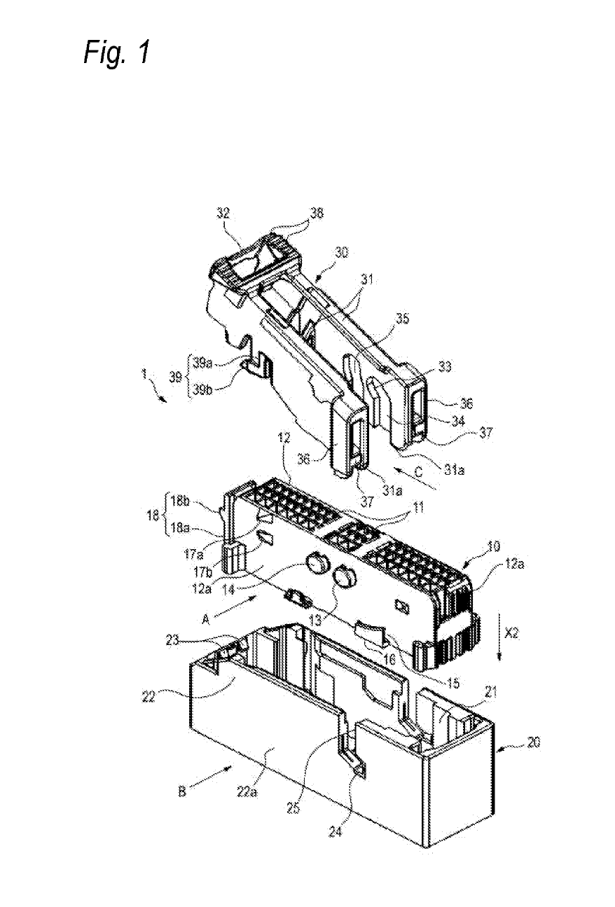

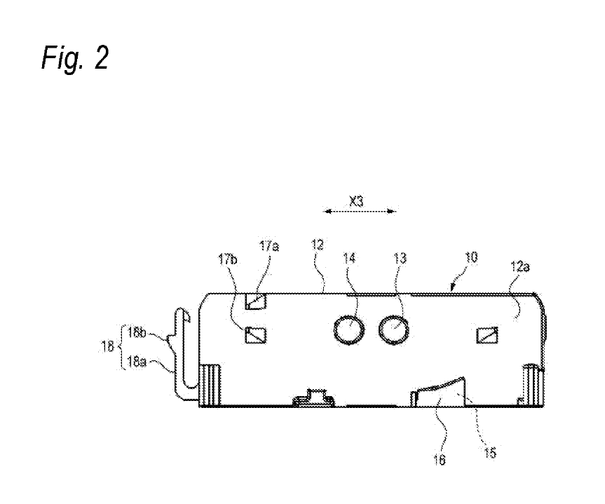

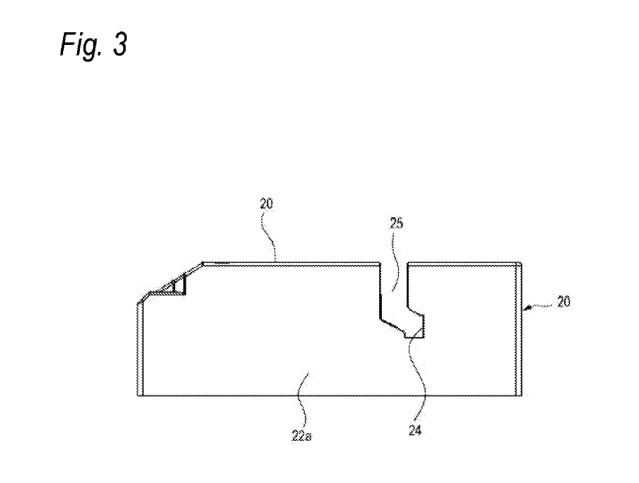

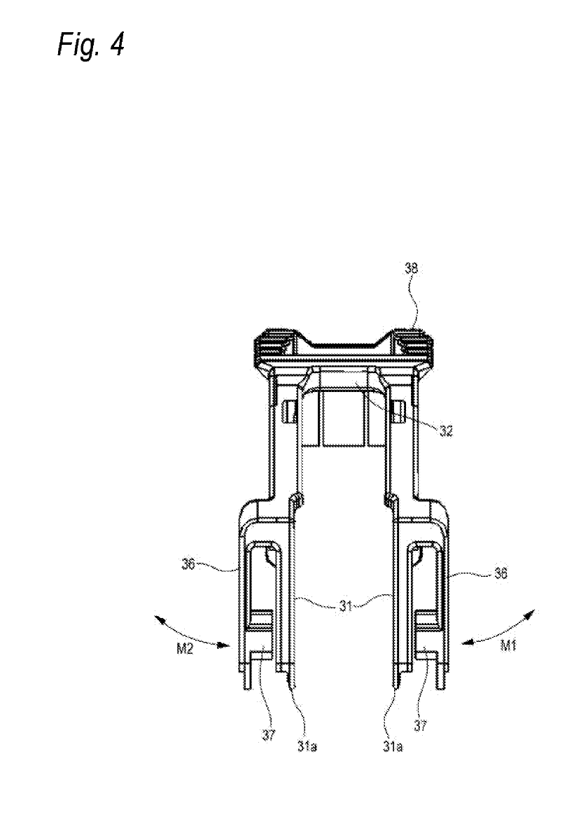

FIGS. 1 to 4 show an embodiment of a lever-type connector according to the invention. FIG. 1 is an exploded perspective view of the lever-type connector of the embodiment of the invention. FIG. 2 is a side view of a first connector housing shown in FIG. 1 (a view as seen in a direction indicated by an arrow B). FIG. 3 is a side view of a second connector housing shown in FIG. 1 (a view as seen in the direction indicated by the arrow B). FIG. 4 is a view of the fitting operation lever shown in FIG. 1 as seen in a direction indicated by an arrow C therein.

This lever-type connector 1 of the embodiment includes, as shown in FIG. 1, a first connector housing 10, a second connector housing 20 in which the first connector housing 10 is fitted for connection, and a fitting operation lever 30 which is rotatably mounted on the first connector housing 10.

As shown in FIG. 1, the first connector housing 10 includes a terminal accommodating portion 12 in which a number of terminal accommodating holes 11 are arranged, boss portions 13 which are provided on both outer surfaces 12a of the terminal accommodating portion 12 so as to project therefrom to thereby support rotatably a fitting operation lever 30, lever placement restricting boss portions 14 which are disposed on the outer surfaces 12a so as to lie close to the boss portions 13, lever guiding ribs 16 which define guiding grooves 15 through which lever main bodies 31 of the fitting operation lever 30, which will be described later, pass so that the lever main bodies 31 do not move away from the outer surfaces 12a, pairs of positioning projections 17a, 17b which restrict the position of the fitting operation lever 30 which is mounted on the first connector housing 10 to an initial position, and a locking piece 18 which is brought into engagement with the second connector housing 20 when the connector housings are fitted together completely to hold them in a joined state.

The outer surfaces 12a of the terminal accommodating portion 12 constitute outer surfaces of the first connector housing 10.

The lever placement restricting boss portions 14 are provided so as to be spaced apart from the corresponding boss portions 13 in a horizontal direction (in a direction indicated by an arrow X3 in FIG. 2). The lever placement restricting boss portions 14 are provided to restrict a direction in which the fitting operation lever 30, which will be described later, is placed when the fitting operation lever 30 is placed on the first connector housing 10 so as to be mounted thereon.

The lever guiding ribs 16 define the guiding grooves 15 through which lower edge portions of the lever main bodies 31, which will be described later, are inserted when the fitting operation lever 30 is rotated and are provided at distal end sides of the outer surfaces 12a as shown in FIG. 2. The lever guiding ribs 16 restrict the lever main bodies 31 from being deflected and displaced in an outward direction which is orthogonal to the outer surfaces 12a when the lever main bodies 31 are rotated.

The pairs of positioning projections 17a, 17b position the lever main bodies 31, which will be described later, in the initial position with the lever main bodies 31, which will be described later, held between the pairs of positioning projections 17a, 17b. When referred to herein, the initial position means a position where action point projecting portions which are provided on the lever main bodies 31, which will be described later, are brought into engagement with lever locking holes 24 in the second connector housing 20, which will be described later, when the first connector housing 10 and the second connector housing 20 are aligned with a fitting starting position.

As shown in FIG. 2, the locking piece 18 includes an elastic piece 18a which extends from a front end side towards a rear end side of the terminal accommodating portion 12 along a direction in which the connector housings are fitted together (a direction indicated by an arrow X2 in FIG. 1), and an engagement projection 18b which is provided on the elastic piece 18a so as to project therefrom.

The second connector housing 20 has an outer cylindrical wall portion (a hood portion) 22 which defines a fitting space 21 into which the first connector housing 10 is inserted, as shown in FIG. 1. External surfaces of the outer cylindrical wall portion 22 provide an external appearance of the second connector housing 20.

As shown in FIG. 1, the second connector housing 20 of this embodiment includes a locking projection 23, lever locking holes 24 and projection guiding cut-out grooves 25 which communicate with the lever locking holes 24.

The locking projection 23 is provided on an inner surface of the outer cylindrical wall portion 22 which is opposite to the locking piece 18 on the first connector housing 10. This locking projection 23 is brought into engagement with the engagement projection 18b of the locking piece 18 to thereby join the connector housing together when the connector housings are fitted together completely.

The lever locking holes 24 are through holes which are formed in the outer surfaces of the outer cylindrical wall portion 22 so that the action point projecting portions 37 which are provided on the lever main bodies 31, which will be described later, are brought into engagement therewith. The second connector housing 20 is joined to the action point projecting portions 37 on the lever main bodies 31 by the engagement of the action point projecting portions 37 with the lever locking holes 24 and moves together with the action point projecting portions 37 in the fitting direction of the connector housings as the lever main bodies 31 rotate.

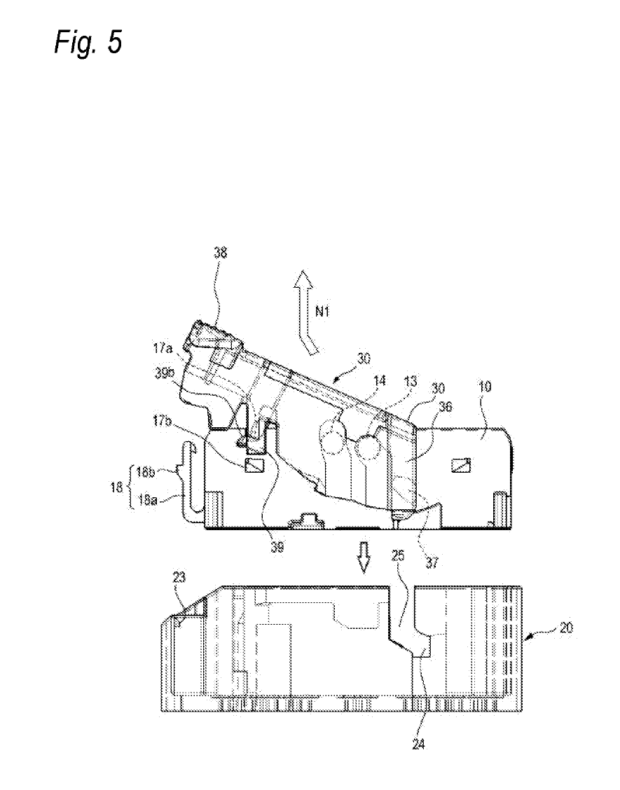

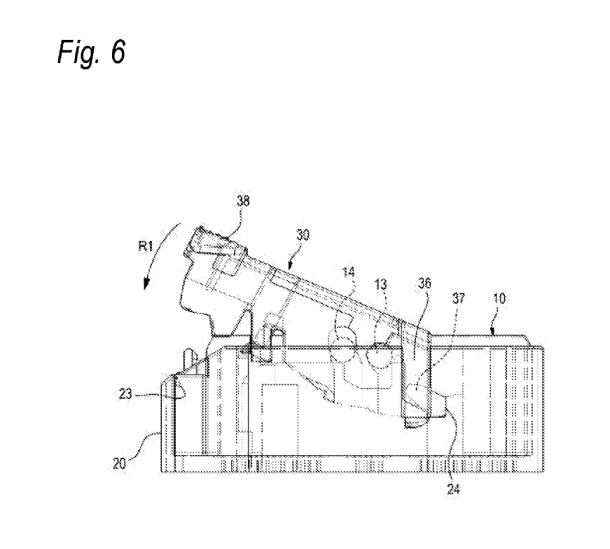

The projection guiding cut-out grooves 25 are guide grooves which guide the action point projecting portions 37 into the lever locking holes 24 when the first connector housing 10 on which the fitting operation lever 30 is mounted is repositioned from a position shown in FIG. 5 where the first connector housing 10 is disposed to be aligned with the second connector housing 20 vertically to a position shown in FIG. 6 where the first connector housing 10 is aligned with the fitting starting position of the connector housings. The projection guiding cut-out grooves 25 are grooves which are cut out of the outer cylindrical wall portion 22 so that the action point projecting portions 37 are inserted therethrough.

The fitting operation lever 30 is rotatably mounted on the first connector housing 10 as a lever member which reduces operation forces to be exerted when the first connector housing 10 and the second connector housing 20 are fitted together and are released from the fitted state.

As shown in FIG. 1, the fitting operation lever 30 includes a pair of lever main bodies 31 which are disposed opposite to each other so as to hold the pair of outer surfaces 12a of the first connector housing 10 therebetween, a connecting member 32 which connects together end portions of the pair of lever main bodies 31, rotation fulcrum holes 33 which are brought into rotational engagement with the boss portions 13 on the first connector housing 10, boss guiding grooves 34 which communicate with the rotation fulcrum holes 33, placement restricting grooves 35 which are disposed close to the boss guiding grooves 34, flexible arms (boss arms) 36, the action point projecting portions 37, an application point portion 38, and temporary locking arms 39.

The pair of lever main bodies 31 are lever members which are placed on the pair of outer surfaces 12a of the first connector housing 10.

The connecting member 32 joins the end portions of the pair of lever members 31 to integrate them with each other, as also shown in FIG. 4.

The rotation fulcrum holes 33 are, as shown in FIG. 1, circular holes which are formed on inner surfaces of the lever main bodies 31 which lie to be opposite to the outer surfaces 12a of the first connector housing 10 in such a way as to be depressed thereinto for rotational engagement with boss portions 13 which are provided individually on the outer surfaces 12a of the first connector housing 10 so as to project therefrom, making the boss portions 13 function as a fulcrum of rotation.

The boss guiding grooves 34 are grooves which are formed on inner surfaces of the lever main bodies 31 so as to be depressed thereinto so that the boss portions 13 can be inserted therethrough. The boss guiding groove 34 extends from the rotation fulcrum hole 33 to a lower edge 31a of the lever main body 31 along the fitting direction of the connector housings (in the direction indicated by the arrow X2 in FIG. 1) and is opened in the lower edge 31a. The boss guiding grooves 34 enable an engagement or disengagement between the boss portions 13 and the rotation fulcrum holes 33 by allowing the lever main bodies 31 to be placed on or displaced from the first connector housing 10 along the fitting direction the connector housings (the direction indicated by the arrow X2 in FIG. 1).

The placement restricting grooves 35 are grooves which are formed on the inner surfaces of the lever main bodies 31 so as to be depressed thereinto so that the lever placement restricting boss portions 14 can be inserted therethrough. The placement restricting grooves 35 are formed substantially parallel to the boss guiding grooves 34.

The lever placement restricting boss portions 14 are inserted through the placement restricting grooves 35 when the fitting operation lever 30 is placed to be mounted on the first connector housing 10, whereby the fitting operation lever 30 is prevented from being inclined inadvertently, thereby making it possible to facilitate the placement and mounting of the fitting operation lever 30 on the first connector housing 10.

The flexible arms 36 extend from the lever main bodies 31 so as to be superposed on the outer surfaces 22a of the outer cylindrical wall portion 22 when the first connector housing 10 on which the rotation fulcrum holes 33 are in rotational engagement with the boss portions 13 and the second connector housing 20 are started to be fitted together where the first connector housing 10 and the second connector housing 20 are aligned with the fitting starting position.

This flexible arm 36 is formed into a plate spring shape of which a surface is parallel to the outer surface 22a of the outer cylindrical wall portion 22 and can be deflected and displaced (elastically displaced) in a direction which is orthogonal to the outer surface 22a as indicated by arrows M1, M2 in FIG. 4.

The operation point projecting portions 37 are projecting portions which are provided at distal end sides of the flexible arms 36 so as to project therefrom for engagement with the lever locking holes 24 which are formed in the outer surfaces 22a of the outer cylindrical wall portion 22 when the connector housings are started to be fitted together.

The application point portion 38 is a portion which receives an operation force that is applied to rotate the lever main bodies 31 on the boss portions 13 as a center of rotation. In this embodiment, portion of an external surface of the connecting member 32 constitutes the application point portion 38.

As shown in FIG. 1, the temporary locking arms 39 each include an elastic piece 39a which extends from the lever main body 31 along the outer surface 12a and an engagement portion 39b which is provided at a distal end side of the elastic piece 39a. With the rotation fulcrum holes 33 in the lever main bodies 31 in rotational engagement with the boss portions 13 on the first connector housing 10, when the lever main bodies 31 are positioned in a predetermined angular position, the engagement portions 39b fit between the pairs of positioning projections 17a, 17b on the first connector housing 10 to thereby fix temporarily the fitting operation lever 30 at a predetermined inclination angle. This temporarily fixed position is a so-called initial position of the fitting operation lever 30. When the connector housings are aligned with the fitting starting position while the fitting operation lever 30 stays in the initial position, the action point projecting portions 37 can be positioned in the lever locking holes 24 in the second connector housing 20.

In the case of the lever-type connector 1 of this embodiment, in the event that the action point projecting portions 37 are brought into engagement with the lever locking holes 24 in the second connector housing 20 when the connector housings are started to be fitted together, the lever main bodies 31 are rotatably joined to the second connector housing 20. Then, when the fitting operation lever 30 is rotated towards the second connector housing 20, the connector housings are fitted together deeply as a result of the fitting operation lever 30 acting as a lever, whereby the connector housings are fitted together completely. Then, with the connector housings fitted together completely for connection by the rotational operation of the fitting operation lever 30, by deflecting and displacing the distal end sides of the flexible arms 36 in a direction in which the distal end sides of the flexible arms 36 move away from the outer surfaces 22a of the outer cylindrical wall portion 22, the engagement of the action point projecting portions 37 with the lever locking holes 24 can be released.

Next, a method of fitting and connecting together the connector housings of the lever-type connector 1 of the embodiment will be described based on FIGS. 5 to 10.

When the connector housings are fitted and connected together, as shown in FIG. 5, the first connector housing 10 on which the fitting operation lever 30 is mounted and the second connector housing 20 are disposed to be opposite to each other. The fitting operation lever 30 mounted on the first connector housing 10 can be removed from the first connector housing 10 by being pulled in a direction indicated by an arrow N1 in FIG. 5 in relation to the first connector housing 10. Additionally, the fitting operation lever 30 can be mounted rotatably on the first connector housing 10 in a simple fashion by being lowered in a reverse direction to the direction indicated by the arrow N1 in FIG. 5 in relation to the first connector housing 10.

It is noted that the fitting operation lever 30 which is mounted on the first connector housing 10 is set to the initial position where the engagement portions 39b of the temporary locking arms 39 are fitted between the positioning projections 17a, 17b on the first connector housing 10 for engagement therewith, as shown in FIG. 5.

Next, the connector housings which are disposed opposite to each other are aligned with the fitting starting position as shown in FIG. 6. By the connector housings being aligned with the fitting starting position, the action point projecting portions 37 of the fitting operation lever 30 are brought into engagement with the lever locking holes 24 in the second connector housing 20.

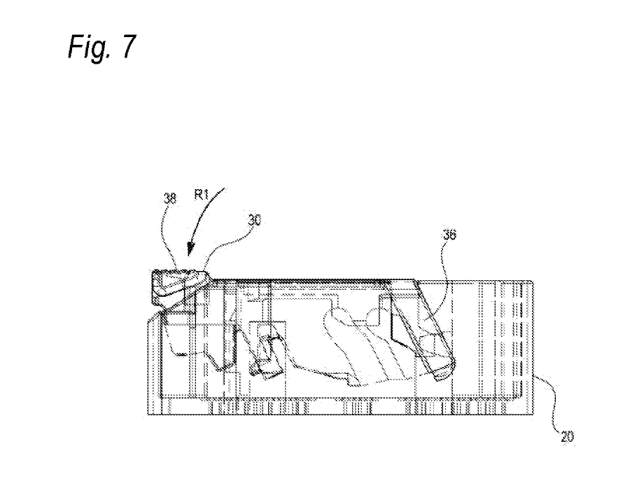

When the application point portion 38 of the fitting operation lever 30 is rotated in a direction indicated by an arrow R1 from the state shown in FIG. 6 where the connector housings are aligned with the fitting starting position, the connector housings are fitted together deeply in association with the rotation of the fitting operation lever 30. Then, when the rotation of the fitting operation lever 30 is completed, as shown in FIG. 7, the connector housings are fitted together completely for connection.

Additionally, in such a state that the connector housings are fitted together completely for connection, the locking piece 18 of the first connector housing 10 is in engagement with the locking projection 23 of the second connector housing 20, whereby the connection of the first connector housing 10 and the second connector housing 20 is locked.

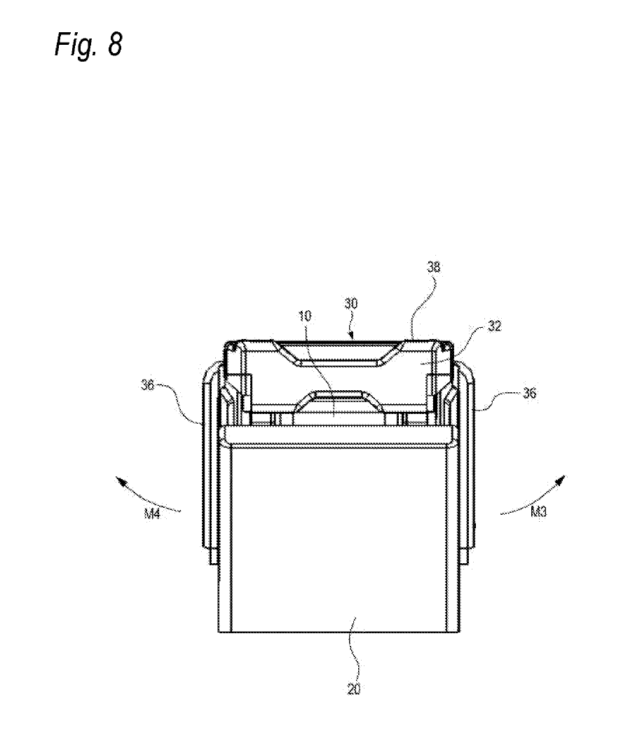

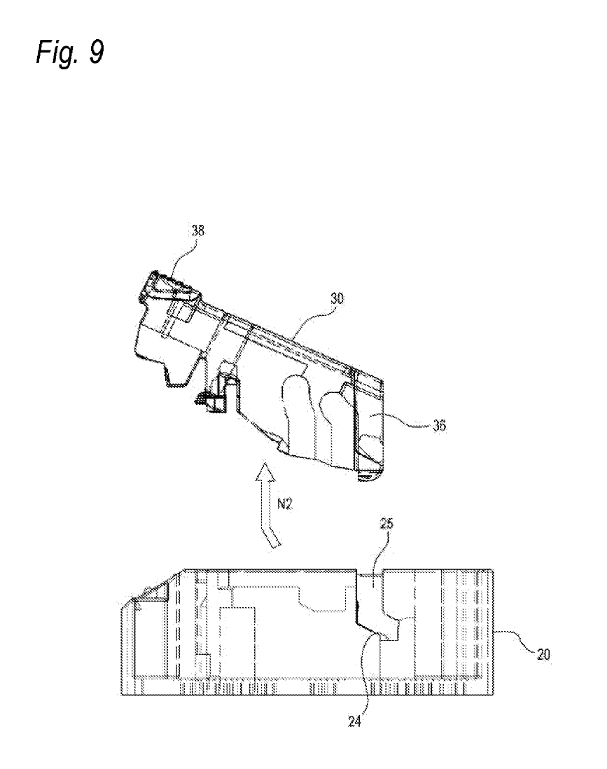

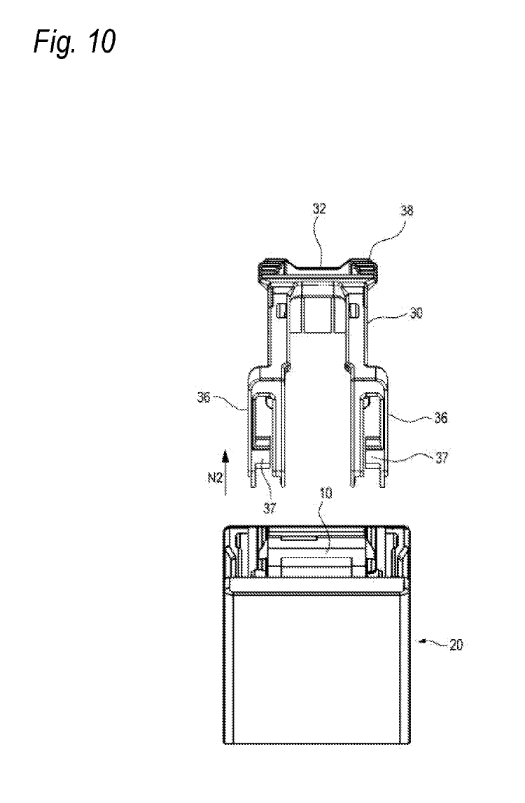

Then, with the connector housings fitted together completely for connection, when the distal end sides of the flexible arms 36 are deflected and displaced in the direction in which the distal end sides of the flexible arms 36 move away from the outer surfaces 22a of the outer cylindrical wall portion 22 as indicated by arrows M3, M4 in FIG. 8, the engagement of the action point projecting portions 37 with the lever locking holes 24 can be released. In such a state that the engagement of the action point projecting portions 37 with the lever locking holes 24 is released, when the fitting operation lever 30 is pulled in a direction indicated by an arrow N2 in FIGS. 9 and 10, the fitting operation lever 30 can be disengaged from the first connector housing 10 and the second connector housing 20.

When the lever-type connector 1 is used normally, by disengaging the fitting operation lever 30, the weight of the lever-type connector 1 can be reduced.

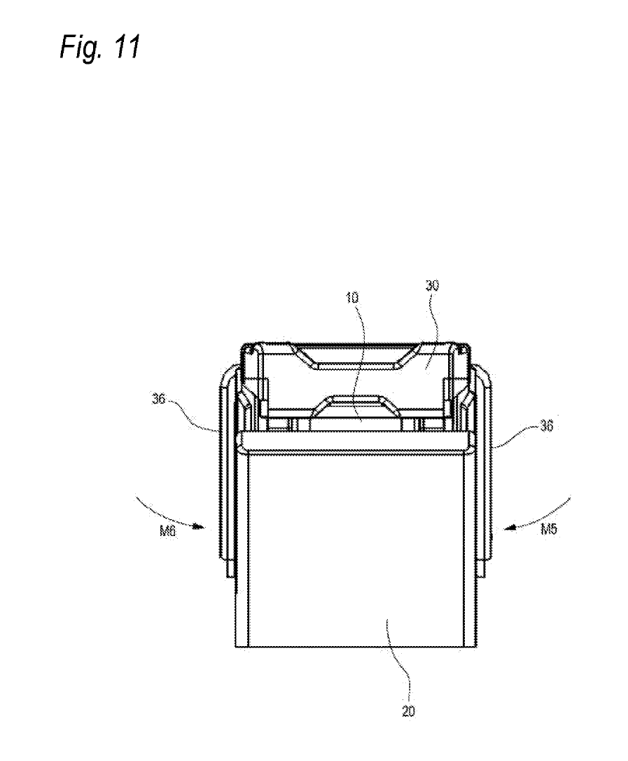

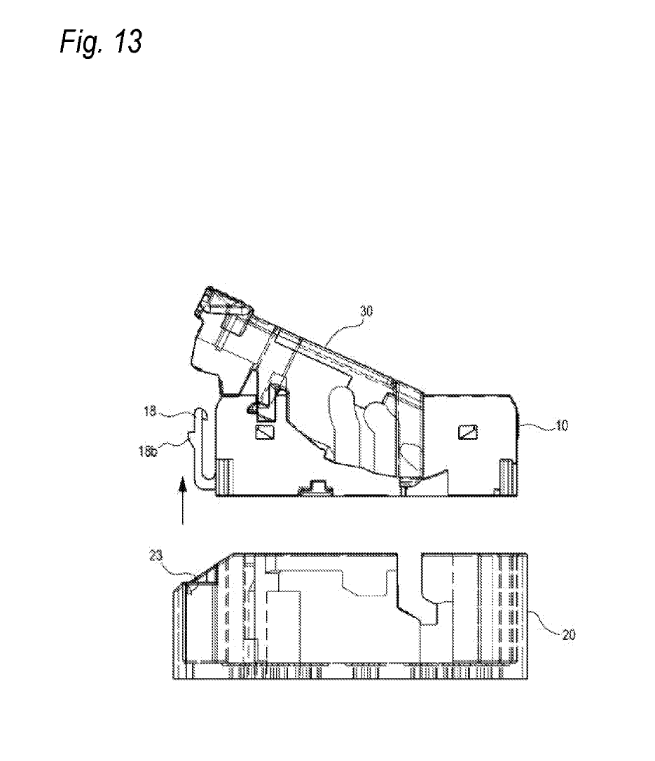

Next, a procedure of releasing the connector housings from the fitted state will be described based on FIGS. 11 and 13.

Firstly, the fitting operation lever 30 which is disengaged from the connector housings is mounded on the first connector housing 10 and the second connector housing 20 which are fitted together for connection. As this occurs, the fitting operation lever 30 is placed to be mounted on the connector housings 10, 20 which are fitted together for connection in a reverse direction to the disengaging direction with the pair of flexible arms 36 deflected outwards. Thereafter, the flexible arms 36 which are so deflected and displaced are restored in directions indicated by arrows M5, M6 in FIG. 11, whereby the action point projecting portions 37 of the fitting operation lever 30 can be brought into engagement with the lever locking holes 24 in the second connector housing 20. This enables the fitting operation lever 30 to be restored to the state shown in FIG. 7.

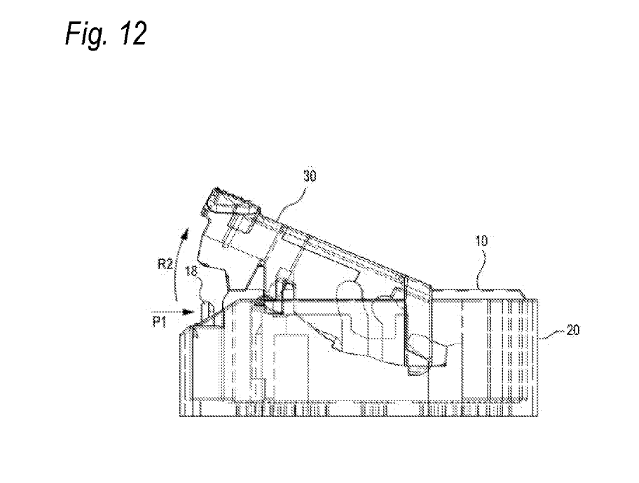

Following this, the fitting operation lever 30 is returned to its initial position as indicated by an arrow R2 in FIG. 12, whereby the first connector housing 10 and the second connector housing 20 can be restored to the state resulting when they were started to be fitted together.

Following this, the locking piece 18 is deflected and displaced in a direction indicated by an arrow P1 in FIG. 12 to release the engagement of the engagement projection 18b with the locking projection 23. Then, the fitting operation lever 30 and the first connector housing 10 are pulled apart from the second connector housing 20 as shown in FIG. 13, whereby the connector housings can be restored to the state where the engagement therebetween is released.

According to the lever-type connector 1 of the embodiment that has been described heretofore, when the fitting operation lever 30 which is mounted on the first connector housing 10 is rotated in the predetermined direction (the direction indicated by the arrow R1 in FIG. 6) with the connector housings aligned with the fitting starting position as shown in FIG. 6, the fitting operation lever 30 functions as a lever member to move the connector housings in the direction in which the connector housings are fitted together deeply, whereby the connector housings are fitted together completely as shown in FIG. 7.

In addition, with the connector housings fitted together completely, the flexible arms 36 of the fitting operation lever 30 are exposed to the outer surfaces of the outer cylindrical wall portion 22 of the second connector housing 20 and can be touched from the outside. Because of this, the engagement between the action point projecting portions 37 and the lever locking holes 24 can be released by deflecting and displacing the distal end sides of the flexible arms 36 in the direction in which the distal end sides of the flexible arms 36 move away from the outer surfaces 22a of the outer cylindrical wall portion 22 as shown in FIG. 8.

In addition, the fitting operation lever 30 can be placed or displaced along the fitting direction of the connector housings, whereby the boss portions 13 can be brought into engagement with or disengagement from the rotation fulcrum holes 33. Because of this, with the coupled state of the fitting operation lever 30 to the second connector housing 20 canceled by releasing the engagement of the action point action point projecting portions 37 with the lever locking holes 24, the fitting operation lever 30 can simply be disengaged from both the connector housings as shown in FIGS. 9 and 10 by removing the fitting connection lever 30 from the first connector housing 10.

Namely, according to the configuration of the embodiment, after the connector housings are fitted together completely for connection, the fitting operation lever 30 is disengaged from both the connector housings, thereby making it possible to realize a reduction in weight of the lever-type connector when in use.

Additionally, the fitting operation lever 30 which is so disengaged can be used to execute a fitting operation on another lever-type connector. This enables a normal parts set for the fitting operation lever 30 to be made up of only a first connector housing 10 and a second connector housing 20 excluding a fitting operation lever 30, thereby making it possible to realize a reduction in cost by reducing the number of parts involved in the parts set.

The invention is not limited to the embodiment that has been described heretofore and can be modified, improved or the like as required. In addition, the materials, shapes, dimensions, numbers, where to dispose the constituent elements and the like are arbitrary and there is imposed no limitation thereon, provided that the invention can be achieved thereby.

While the invention has been described in detail and by reference to the specific embodiment, it is obvious to those skilled in the art to which the invention pertains that various alterations or modifications can made thereto without departing from the spirit and scope of the invention.

This patent application is based on Japanese Patent Application (No. 2012-025349) filed on Feb. 8, 2012, the contents of which are incorporated herein by reference.

The characteristics of the lever-type connector according to the invention which has been described by reference to the embodiment will be enumerated briefly altogether under [1] below.

[1] A lever-type connector, including:

a first connector housing (10);

a second connector housing (20) having an outer cylindrical wall portion (22) into which the first connector housing (10) is inserted and configured to be fitted together with the first connector housing (10) for connection;

a fitting operation lever (30) which is rotatably mounted on the first connector housing (10) as a lever member which reduces operation forces to be exerted when the first connector housing (10) and the second connector housing (20) are fitted together and are released from the fitted state;

wherein the fitting operation lever (30) includes:

a pair of lever main bodies (31) which are disposed opposite to each other so as to hold a pair of outer surfaces of the first connector housing (10) therebetween;

rotation fulcrum holes (33), which are formed on inner surfaces of the lever main bodies (31) which lie to be opposite to the outer surfaces of the first connector housing (10), and which are depressed thereinto for rotational engagement with boss portions (13) which are provided individually on the outer surfaces of the first connector housing (10) so as to project therefrom;

boss guiding grooves (34) which are formed on inner surfaces of the lever main bodies (31a) and depressed thereinto so as to enable an engagement or disengagement between the boss portions (13) and the rotation fulcrum holes (33) by allowing the lever main bodies (31) to be placed on or displaced from the first connector housing (10) along a direction in which the connector housings are fitted together;

flexible arms (36) which extend from the lever main bodies (31) so as to be superposed on outer surfaces of the outer cylindrical wall portion at a fitting starting time when the first connector housing (10) and the second connector housing (20) are started to be aligned with a fitting starting position on which the rotation fulcrum holes (33) are in rotatable engagement with the boss portions (13);

operation point projecting portions (37) which are provided at distal end sides of the flexible arms (36) so as to project therefrom for engagement with lever locking holes (24) which are formed in the outer surfaces of the outer cylindrical wall portion (22) when the connector housings are started to be fitted together; and

an application point portion (38) which receives an operation force that is applied to rotate the lever main bodies (31) on the boss portions (13) as a center of rotation,

and

wherein the engagement between the action point projecting portions (37) and the lever locking holes (24) can be released by deflecting and displacing the distal end sides of the flexible arms (36) in a direction in which the distal end sides of the flexible arms (36) move away from the outer surfaces of the outer cylindrical wall portion (22).

### INDUSTRIAL APPLICABILITY

According to the lever-type connector of the invention, after the connector housings are fitted together completely, the fitting operation lever is disengaged from both the connector housings, thereby making it possible to realize a reduction in weight of the lever-type connector when in use.

Additionally, the fitting operation lever which is so disengaged can be used to execute a fitting operation on another lever-type connector. This enables a normal parts set for the fitting operation lever to be made up of only a first connector housing and a second connector housing excluding a fitting operation lever, thereby making it possible to realize a reduction in cost by reducing the number of parts involved in the parts set.

### DESCRIPTION OF REFERENCE NUMERALS

1 lever-type connector
10 first connector housing
12 terminal accommodating portion
12a outer surface
13 boss portion
20 second connector housing
22 outer cylindrical wall portion (hood portion)
22a outer surface
24 lever locking hole
30 fitting operation lever
31 lever main body
33 rotation fulcrum hole
34 boss guiding groove
35 placement restricting groove
36 flexible arm (boss arm)
37 action point projecting portion
38 application point portion

1. A lever-type connector, comprising:
a first connector housing;
a second connector housing having an outer cylindrical wall portion into which the first connector housing is inserted and configured to be fitted together with the first connector housing for connection; and
a fitting operation lever which is rotatably mounted on the first connector housing as a lever member which reduces operation forces to be exerted when the first connector housing and the second connector housing are fitted together and are released from the fitted state;
wherein the fitting operation lever includes:
a pair of lever main bodies which are disposed opposite to each other so as to hold a pair of outer surfaces of the first connector housing therebetween;
rotation fulcrum holes, which are formed on inner surfaces of the lever main bodies which lie to be opposite to the outer surfaces of the first connector housing, and which are depressed thereinto for rotational engagement with boss portions which are provided individually on the outer surfaces of the first connector housing so as to project therefrom;
boss guiding grooves which are formed on inner surfaces of the lever main bodies and depressed thereinto so as to enable an engagement or disengagement between the boss portions and the rotation fulcrum holes by allowing the lever main bodies to be placed on or displaced from the first connector housing along a direction in which the connector housings are fitted together;
flexible arms which extend from the lever main bodies so as to be superposed on outer surfaces of the outer cylindrical wall portion at a fitting starting time when the first connector housing and the second connector housing are started to be aligned at a fitting starting position in a state that the rotation fulcrum holes are in rotatable engagement with the boss portions;
operation point projecting portions which are provided at distal end sides of the flexible arms so as to project therefrom for engagement with lever locking holes which are formed in the outer surfaces of the outer cylindrical wall portion when the connector housings are started to be fitted together; and
an application point portion which receives an operation force that is applied to rotate the lever main bodies on the boss portions as a center of rotation, and
wherein the engagement between the action point projecting portions and the lever locking holes can be released by deflecting and displacing the distal end sides of the flexible arms in a direction in which the distal end sides of the flexible arms move away from the outer surfaces of the outer cylindrical wall portion.
